(19) United States
(12) Patent Application Publication
(10) Pub. No.: US 2009/0013937 A1
(43) Pub. Date: Jan. 15, 2009

(54) Cat4play in door out door light weight fat cat scratch playhouse

(76) Inventor: Judy Faye Ray Coggins, Chula Vista, CA (US)

Correspondence Address: Juddy Faye Ray Coggins, 671 Arthur Ave., Chula Vista, CA, 91910, US

(21) Appl. No.: 12/220,108

(22) Filed: Jul. 22, 2008

Related U.S. Application Data
(63) Continuation-in-part of application No. 11/299,190, filed on Dec. 9, 2005, now abandoned.

(51) Int. Cl. A01K 1/035; A01K 15/02

(52) U.S. Cl. 119/706; 119/484

(57) ABSTRACT

A modular cost effective cat play-home unit comprised of a grid form, suitable, reusable frame material covered with a non-carpet cat scratching alternative material made from EVA flexible foam that cats prefer to scratch and comes in a variety of colors to accent any interior or exterior design decor and is resistant to bacteria, water, urine, feces, hair, stain, odor, fire and is veterinarian approved as healthy and non-toxic to felines and canines, collapsible and lightweight for easy transport, storage or shipment and can be easily sanitized with disinfectant spay and quickly wiped dry or sun dried for energy efficiency creating a generation of cats taught not to scratch carpet whereas each inventive mat can be used by veterinarian offices as surgical stretchers allowing for easy transport to cages whereas the pet is protected with a soft, thermal healthy flexible matting that can be tilted for visible waste release.

### CROSS-REFERENCES TO RELATED APPLICATIONS

This is a CIP of prior application Ser. No. 11/299,190, filed Dec. 9, 2005.

| | | | |
|---|---|---|---|
| U.S. Pat. No. D224686-S | 08-1972 | Michlap, Dewitt A | D30\117 |
| U.S. Pat. No. 4,301,766 A | 11-1981 | Piccone, James | 119\482 |
| U.S. Pat. No. 4,347,807 A | 09-1982 | Reich, Mavin | 119\499 |
| U.S. Pat. No. 4,520,758 A | 06-1985 | Pfriender, John A | 119\499 |
| U.S. Pat. No. 5,711,253 A | 01-1998 | Phillips et al | 119\706 |
| U.S. Pat. No. 5,884,586 A | 03-1999 | Carbonelli, | 119\485 |
| | | Antonio F | |
| U.S. Pat. No. 5,964,189 A | 10-1999 | Northrop, Antonio F | 119\485 |
| U.S. Pat. No. 6,024,051 A | 02-2000 | Simantob et al | 119\431 |
| U.S. Pat. No. 6,158,183 A | 02-2000 | Snell, Thomas | 52\268 |
| | | Bartlett | |
| U.S. Pat. No. 6,431,119 B1 | 08-2002 | Beymer, Cyndi, M | 119\485 |
| U.S. Pat. No. 6,857,393 B2 | 03-2005 | Cheshire, Jill | 119\455 |
| U.S. Pat. No. 2005\0059500 | 03-2005 | Finsteine, Nathan | 472\088 |
| A1 | | | |
| U.S. Pat. No. 6,886,495 B1 | 05-2005 | Madden, et, al | 119\482 |
| U.S. Pat. No. 3,561,757 A | 02-1971 | Schillig, William C. | 482\35 |
| U.S. Pat. No. 4,803,952 A | 02-1989 | Houser, David B. | 119\499 |
| U.S. Pat. No. 5,050,536 A | 09-1991 | Baker, Reginald, D | 119\499 |
| U.S. Pat. No. 5,080,042 A | 01-1992 | Rubin, Bert L | 119\706 |
| U.S. Pat. No. 5,092,277 A | 03-1992 | Baillie et al | 119\165 |
| U.S. Pat. No. D349,783 S | 08-1994 | Berger, Micheal L | D30\108 |
| U.S. Pat. No. 5,465,682 A | 11-1995 | Chavallo, Jr, | 119\498 |
| | Eusevio | | |
| U.S. Pat. No. 5,724,916 A | 03-1998 | Brodie et al | 119\525 |
| U.S. Pat. No. 6,390,025 B1 | 05-2002 | Babcock et al. | 119\482 |
| U.S. Pat. No. 6,558,295 B2 | 05-2003 | Araki et al | 482\35 |
| U.S. Pat. No. 3.259.264 A | 07-1966 | Best John; et al. | 220\4.26 |
| U.S. Pat. No. 5099.866 A | 03-1992 | Sotis et al. | 135\154 |
| U.S. Pat. No. 2004\0224823 | 11-2004 | Myers et al | 482\0351 |
| A | | | |
| U.S. Pat. No. 6,862,809 B2 | 03-2005 | Wieschermann et al | 29\897.2 |
| U.S. Pat. No. 7,134,404, B2 | 11-2006 | Slone, Margaret | 119\501 |

### STATE REGARDING FEDERALLY SPONSORED RESEARCH OR DEVELOPMENT

Not-Applicable

### THE NAMES OF THE PARTIES TO A JOINT RESEARCH AGREEMENT

Not-Applicable

### INCORPORATION-BY-REFERENCE OF MATERIAL SUBMITTED ON A COMPACT DISC

Not-Applicable

### BACKGROUND OF INVENTION

The present invention relates to a non-carpet, modular, lightweight, washable and sanitize-able ethylene-vinyl-acetate (EVA) flexible foam material covered hollow feline play-home. An emphasized advantage for this non-carpet cat play-home is the critical need and extraordinary solution to sanitize and clean plus teach felines not to scratch furniture and carpet by offering an alternative veterinary approved feline scratching material. This unit can be fully submerged into bleach and water for complete sanitizing allowing reuse and cost effective savings to animal foster homes, animal shelters and humane societies. Another advantage of this cat play-home is that the variety of colors of EVA flexible foam panels can match any room design decor or seasonal color change or holiday themes re-using the frame. A bonus benefit of this cat play-home is that the rearrangement of units allows it to fit any space inside or outside the home. A beneficial asset of this cat play-home is that it is lightweight allowing for easy placement by people of all sizes and strengths and allowing the elderly to safely move this unit. A cost effective advantage is that each individual EVA foam panel from the play-home house frame can be replaced and reversed as needed or desired to save money or change color. This unit's best feature is the hollow two-sided scratching design that doubles the surface available for felines to scratch. In only half the usual space it incorporates (47sf) of scratching space inside and outside the unit. This cat play-home unit is constructed of a re-useable lightweight steel grid frame that repels water and urine and collapses for easy transportation, storage and shipping. The swinging doors are sized (1′×1′) allows all sizes of felines access to and from the interior. Prior cat scratching devices have heretofore been units containing outside and inside material that absorbs dangerous germs, bacteria and odors creating offensive odors and dangerous bacteria growth. Another disadvantage of other units is they are heavy and unsafe to move and sometimes become unstable. Prior units do not allow for the replacement of interior or exterior material as one side becomes damaged, dirty and stained. The critical disadvantage of prior units is they are made of carpet giving the felines permission to scratch any carpeted surface including floors.

(1) Field of the Invention

An inventive collapsible lightweight grid form framed cat play-home covered with EVA flexible foam matting that is resistant to water, bacteria, feces, urine, odor, disease and hair. EVA foam is easily sanitized with disinfect spray and can be towel dried or sun dried to make this invention an energy saver.

EVA foam material is veterinary approved as non-toxic to domestic felines and canines and a cat scratching material alternative to the carpet the felines should not scratch. EVA flexible material comes in a variety of colors for any room design or decor to create a cat and customer connection with economical savings that helps save domestic felines. The present invention relates to creating a generation of felines taught to scratch this inventive EVA flexible foam material instead of carpet. This lets our furry family members become energy efficient with this creative, easily movable and reusable framed cat play-home. This invention offers multiple felines approximately (47sf) of scratch surface inside and out. This EVA material repels cat hair, is easily cleaned and sanitized with disinfectant spray and wiped or sun dried.

The present invention's base offers cats (4sf) of hollow interior surface and the tower offers (2sf) of hollow interior surface for felines to climb into. Swinging doors fascinate felines allowing them to sneak inside or out of the play-home offering them a hiding place. Additional purchase of add-on towers and add-on bases offer cat owners multiple room designs including reaching up to the ceiling creating a complete cat room inside or outside the home.

The present invention allows animal shelters, humane societies and animal foster homes an energy efficient and cost saving and affordable cat play-home structure to fit any size cage. Teaching felines to scratch inventive EVA flexible foam material instead of carpet and furniture ensures permanent adoptive homes and reduces the spread of deadly disease inside shelters, humane societies, foster-homes and reduces pet euthanasia. This inventive EVA foam material is energy efficient and bonus uses include the creation of soft dog bedding and coverings for the floors and walls of all domestic pet cages or pet carriers. A cat carrier with inventive EVA flexible foam material protects the domestic pet from sliding during transport allowing comfort for all domestic pets and should an accident occur the mat can be pulled out and hand-washed.

(2) Description of Related Art

US-D224686-S: Michlap's not applicable

U.S. Pat. No. 4,301,766 A: Piccone Not applicable

U.S. Pat. No. 4,347,807 A: Reich's primary objective is a cat condo and although collapsible it is made of wood and carpet. Therefore the unit cannot be sanitized nor does it offer individual replacement of a non-toxic veterinarian approved EVA flexible foam material panels in a variety of colors, therefore it is not applicable.

U.S. Pat. No. 4,520,758 A: Pfriender's patent is a unitary structure that does not offer swinging doors for the cats to enter and exit the unit. Pfriender suggestions of possible structure material covering, however does not provide any specifics such as where to purchase this material, price or the health and toxicity this specific material has on cats. Absent specific directions for the customers to adhere specific covering material including the toxicity of a possible dangerous chemical to cats, dogs and children creates a possible dangerously patent. This patent is not applicable to the present invention for a healthy veterinarian approved non-toxic EVA flexible foam material safe for cats, dogs and humans.

U.S. Pat. No. 5,711,253 A: Phillips Not applicable.

U.S. Pat. No. 5,884,586 A: Carbonelli's primary objectives are to enclose food and water and it is made of carpet and rope. It does not address the sanitation, weight, and economic savings, energy savings of the present claimed unit and does not address felines scratching carpet therefore it is not applicable.

U.S. Pat. No. 5,964,189 A: Northrop's primary objectives are a carpeted and rope unit that's primary object is to hide cat food and water dishes, therefore is not applicable.

U.S. Pat. No. 6,024,051 A: Simantob Not applicable

U.S. Pat. No. 6,158,183 A: Snell's primary objective is to use EVA foam for sanitization of veterinary walls primarily for barnyard animals focusing on flushing waste from animals and comforting them in a clinical environment. It does not address domestic pets such as felines who naturally scratch residential carpet, therefore it is not applicable.

U.S. Pat. No. 6,431,119 B1 A: Beymer's primary objectives are to cover a litter box inside a cathouse with cabinets for storage, therefore it is not applicable.

U.S. Pat. No. 6,857,393 B2: Chesire's primary objective is a habitat, cage-less with clear plastic to visualize felines yet does not address the critical need to teach felines not to scratch carpet. Chesire's invention ignores the human desires for modular, flexible and colored flexible foam material panels that meet all veterinary sanitation requirements and therefore it is not applicable.

US-2005\0059500 A1: Finsteine, is a child's play-home unit and therefore not applicable.

U.S. Pat. No. 6,886,495 B1 Malden's primary objective is a light weight frame however it does not address the critical need to teach felines not to scratch carpet is not cost-effective or offer savings with complete sanitize-able, replaceable, reversible and flexible foam material colored panels

U.S. Pat. No. 3,561,757 A Schilling's not applicable

U.S. Pat. No. 4,803,952 A. Houser's primary objective is a children's play-home and therefore is not applicable.

U.S. Pat. No. 5,050,536 A. Baker's primary objectives are enclosing a pet's water, food, and litter box. This invention ignores a veterinarian approved non-toxic and sanitize-able interior scratch surface material and therefore is not applicable.

U.S. Pat. No. 5,080,042 A. Rubin cited a plurality of possible carpet covered wood panels sliding into fixed cube shaped frames creating a heavy and expensive unit to ship and transport. Carpet and wood absorbs water, bacteria, urine and feces is a non-healthy animal play-home unit that is impossible to sanitize. The unavailability of individual carpet panel replacements is a financial hardship for a low income cat owner. Carpeted panels do not address the critical need to teach felines not to scratch carpet. Placing cubes together limits the size of open interior space for cats to play and lounge. This patent does not offer swinging doors for feline amusement and easy entrance and exit access, therefore it is not applicable.

U.S. Pat. No. 5,092,277 A Baillie's primary objective is covering a litter box, therefore it is not applicable.

US-D349,783 S Berger's primary objective is an ornamental design only for cathouses, therefore it is not applicable.

U.S. Pat. No. 5,465,682 A Chavallo's primary objective is modular living structure for cats including food and litter compartments comprised of carpet, fabric and a turf mat. This invention doesn't offer a variety of colors to meet customer desired interior design decor and weather resistant exterior residential design décor. It does not address the critical need to teach cats not to scratch carpet or material covered furniture. Whereas this patent offers no means of cleaning and sanitizing and replacing scratching material and therefore it is not applicable.

U.S. Pat. No. 5,724,916 A Brodie claims puncture resistant EVA foam is a wall and floor covering suitable for animal stalls and stables for livestock and large farm animals, allowing waste to be flushed away to protect the animal. However EVA flexible material foam of present invention is penetrable, can be pierced and pricked allowing domestic felines to pull pieces from unit until it is completely damaged and must be replaced.

U.S. Pat. No. 6,390,025 B1 Babcock's primary objective is a light-weight cage made of PVC pipe made for reptiles and does not suit the needs and desires of felines and therefore it is not applicable.

U.S. Pat. No. 6,558,295 B2 Araki's primary objective is a jungle gym for kids and therefore it is not applicable.

U.S. Pat. No. 7,134,404, B2 Slone's primary objective is a habitat consisting of substantially rigid foam insulation to protect outdoor animals from extreme weather. This habitat does not meet the needs and desires of the family friendly indoor domestic cat and therefore it is not applicable.

### BRIEF DESCRIPTION OF THE INVENTION

A lightweight, modular, collapsible cat play-home unit comprised of individual grid form re-usable frame panels individually covered with an alternative and preferred cat scratch EVA flexible foam panels. These panels are capable of being replaced or reversed as needed or desired with a variety of colors that can be easily and cost effectively sanitized with disinfectant spray and wiped dry. These inventive EVA panels are resistant to bacteria, water, urine, feces, hair, odors and fire allowing for repeated re-use and cost savings to animal shelters and humane societies.

### BRIEF DESCRIPTION OF THE SEVERAL VIEWS OF THE DRAWINGS

FIG. 5 is a functional view of the present invention covered with inventive EVA flexible foam panels showing where cats can enter and exit into and out of the hollow base and hollow tower through the swinging doors.

FIG. 5 shows the hollow tower connected to the hollow base.

FIG. 5 is a visual showing cat's moving inside and outside the tower and base.

FIG. 5 dark gray areas are swinging doors.

FIG. 8 top two figures FIG. 7 and FIG. 8 show the entire unit.

### DETAILED DESCRIPTION OF THE INVENTION

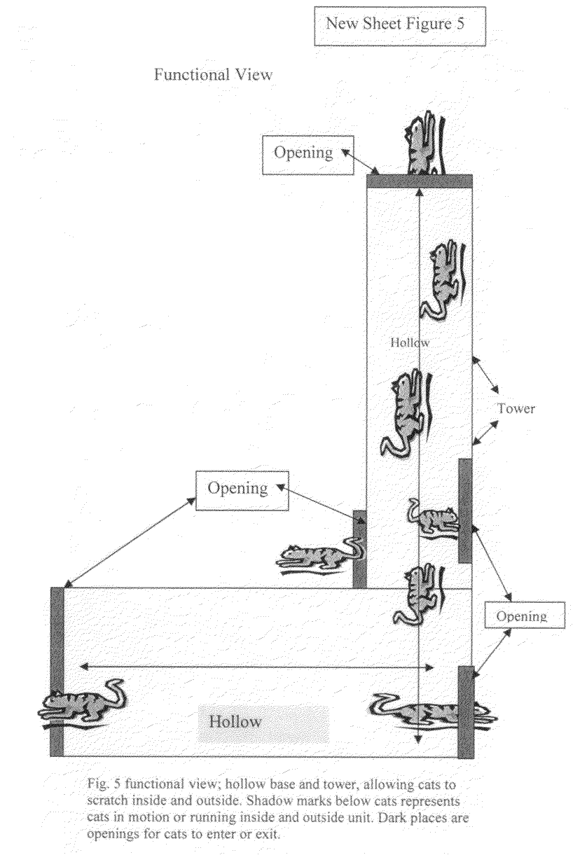

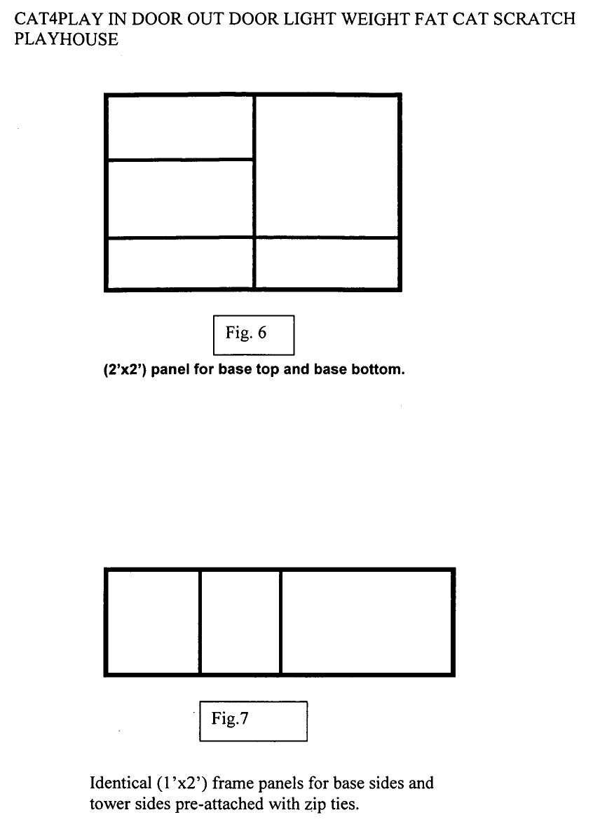

FIG. 5 is a functional view of the present invention covered with inventive EVA flexible foam showing where cats can enter and exit into and out of the base and tower through the dark grey Fig. B swinging doors. EVA foam is pre-attached to all frame panels.

FIG. 6 shows two identical (2′×2′) panels creating the base bottom and base top of the unit.

FIG. 6-A shows detailed assembly instructions of the base (2′×2′×1′) tall.

FIG. 7 shows (1′×2′) panels that construct the base and tower sides.

FIG. 7-A shows detailed assembly instructions for the tower (1′) wide and (2′) tall.

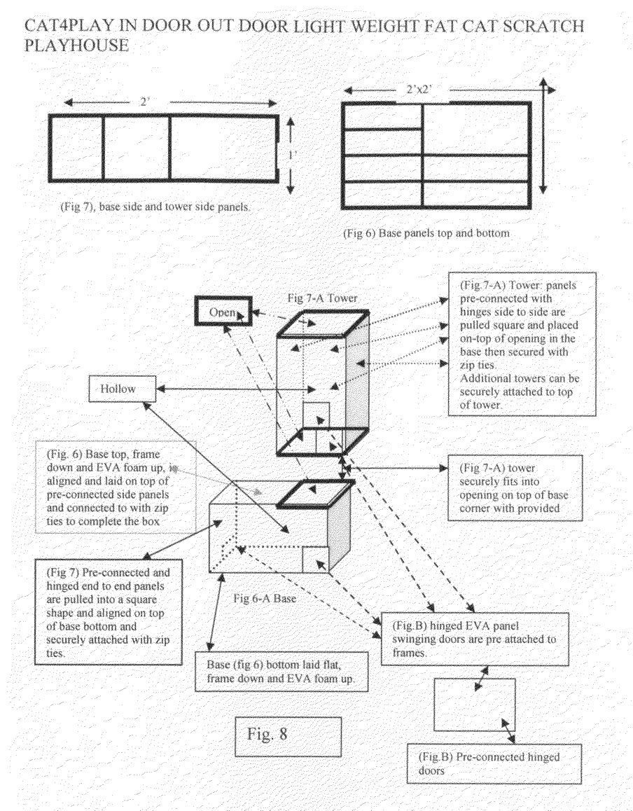

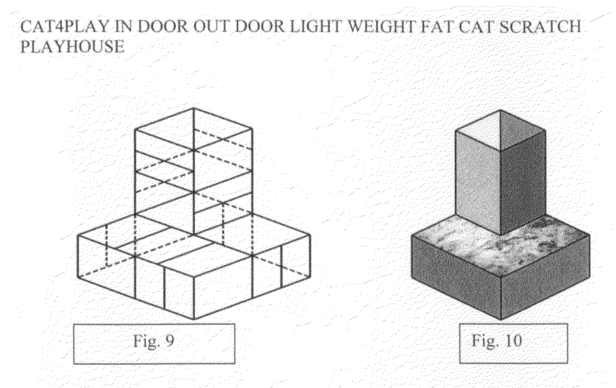

FIG. 8 shows detailed unit assembly instructions.

FIG. 9 visual picture of the present invention's grid form frame unit fully assembled.

FIG. 10 visual picture of the present invention's frame unit covered with EVA variable colored flexible foam material absent visual of the swinging doors.

Place FIG. 6, (2′×2′) panel on a flat surface, frame side up and foam side down.

Take FIG. 7, (1′×2′) panels pre-connected with zip ties on the short ends and pull-open into a square shape and place directly on top of FIG. 6. Align doors accordingly for placement of unit into a space allowing door to fully swing open. Secure side panels FIG. 7 to base bottom, FIG. 6 with provided zip ties at each corner and space one about every (6″) inside all (4) side bottoms. EVA foam is always on outside and frame inside.

Place FIG. 6, (2′×2′) panel on top of pre-assembled square shaped base, frame down and EVA foam up. Align large hole to fit into a corner for tower attachment and insure swinging doors will open fully. Secure top of base with provided zip ties at all four comers and every (6″) along each panel side at the top. Zip ties can be placed inside or outside the frame providing a tough and flexible amusing and attractive toy for cats to play with inside and outside the play-home.

Take remaining side panels FIG. 7, with loosely pre-connected zip ties, attached inside long panels and pull together tight into a tall square shape. The tower has loose zip ties placed every (6″) inside on all (4) comers of tower for stability, just reach inside tower and pull each zip tie tight to complete tower assembly. Tower panels are pre-connected with loose zip ties for shipment purposes. Zip ties on tower can be slid to the outside or inside to provide an excellent play-home toy for cats.

If desired the tower and base can be placed in separate locations to fit any space.

Align tower in a space to ensure doors can fully open if tower and base are placed together. Set assembled tower on top of big square hole in base, insuring swinging doors are fully open and place provided zip ties on all four comers of base and tower and pull tight to secure tower onto base. Cat play-home is fully assembled and can be placed anywhere for cats to enjoy.

Add-on towers can be purchased and connected to the top of the tower for added pleasure for cats.

Individual EVA foam panels are easily removed, reversed or replaced by cutting zip ties and replacing panel with new zip ties into pre-cut holes of pre-cut and sized EVA foam panels.

Inventive unit can be turned in different directions to suit any location and allows for a visually pleasing cat-play-home.

29. I claim a healthy, modular, lightweight and energy efficient cat scratch play-home made from a plurality of grid form frame panels of a suitable substance creating a (4sf) square shaped hollow base, an attachable (2sf) oblong hollow tower covered with an inventive variety of colored ethylene-vinyl-acetate (EVA) flexible foam material panels generating (47sf) of interior and exterior cat scratching surface for multiple domestic felines of various sizes and weights allowing access and egress and comprised of (2) identical square shaped panels (2′×2′) to construct the base top and base bottom and a plurality of pre-connected (1′×2′) frame panels to construct the square base sides and oblong tower sides, all frame panels and EVA flexible foam panels, including one (1′×1′) swinging doors are connected with zip ties making each EVA flexible foam panel capable of being easily replaced, removed or reversed as needed or desired for personal indoor or outdoor residential design decor at a considerable cost effective savings and energy efficient, veterinarian approved non-toxic, healthy flexible foam material resistant to feces, urine, water, bacteria, dangerous germs, dirt, hair and is a hand-washable material that is an alternative cat scratch material to cats scratching carpet that felines prefer to scratch and penetrate with their nails whereas the EVA material is easily disinfectant sprayed and towel and sun dried offering veterinarian offices use as a surgical stretcher for pets to be transported to and from surgical room tables to cages on a thermal soft stretcher that can be tilted to allow waste to naturally flow from pet thereby saving energy as material can be continuously sanitized and reused offering a visual aid for veterinarian staff to view surgical discharge.

30. I claim the healthy cat scratch play-home of the claim 29 wherein each individual panel of the frame unit is individually covered with an EVA flexible foam material and is capable of being easily removed, replaced or reversed from the steel frames using the zip tie connectors as needed or desired.

31. I claim the healthy cat scratch play-home of claim 29 has approximately (4sf) of hollow interior base space and the oblong tower has approximately (2sf) of hollow interior space totaling (47sf) of scratching surface.

32. I claim the healthy cat scratch play-home of claim 29 whereas the EVA flexible foam is veterinarian approved as a healthy and non-toxic material for cats and dogs.

33. I claim the healthy cat scratch play-home of claim 29 whereas the EVA material is resistant to water, bacteria, urine, feces, and fire.

34. I claim the healthy cat scratch play-home of claim 29 whereas the EVA material is hand-washable, easy to clean and sanitize with disinfectant spray and can be towel wiped or sun dried eliminating washer and dryer cleaning wherein energy efficient.

35. I claim the healthy cat scratch play-home of claim 29 whereas the EVA material is available in a variety of colors, holiday colors, artistic colors and designer colors.

36. I claim the healthy cat scratch play-home of claim 29 is comprised of a plurality of identically square shaped (2′×2′) frame panels comprising the base top and base bottom.

37. I claim the healthy cat scratch play-home of claim 29 is comprised of a plurality of (1′×2′) frame panels comprising the base sides and tower sides.

38. I claim the healthy cat scratch play-home of claim 29 whereas the unit fully assembled weighs less than (25) pounds and is easily movable and modular whereas it is collapsible for easy shipment, storage and transportation.

39. I claim the healthy cat scratch play-home of claim 29 whereas the unit is modular and can be modified whereas separating the base and tower and turning base on sides can fit into any indoor or outdoor space.

40. I claim the healthy cat scratch play-home of claim 29 whereas the steel frame unit supports multiple domestic felines having various weights.

41. I claim the healthy cat scratch play-home of claim 29 whereas the cost effective savings and availability of additional add-on steel frame towers and or base units allows unlimited personal cat play-home creations for any interior and exterior design.

42. I claim the healthy cat scratch play-home panel of the claim 29 is capable of being used for veterinarians as a portable stretcher that is a healthy, soft, insulated material resistant to bacteria for use with small domestic animals transported to and from surgery, cages or pens.

43. I claim the healthy cat scratch play-home of claim 29 whereas the EVA material panel has been thoroughly tested by over (1000) cats at a non-profit pet rescue and pet adoption organization and proved that felines preferred to scratch EVA material instead of carpet.

44. I claim the healthy cat scratch play-home of claim 29 whereas EVA material can replace cat scratching products made of carpet and help reduce the number of relinquished, abandoned and/or orphaned felines running loose and overcrowding our shelters and humane societies.

45. I claim the healthy cat scratch play-home of claim 29 whereas each EVA panel is cost-effective whereas the entire unit can be hand-washed and sanitized for re-use at shelters, pet foster homes and humane societies to help create a new generation of felines that can be taught not to scratch carpet or furniture.

46. I claim the healthy cat scratch play-home of claim 29 the grid form frame can be re-used.

47. I claim the healthy cat scratch play-home of claim 29 whereas the EVA flexible foam material can be placed into pet carriers or pet cages to prevent traumatizing movement of animals during transportation.
